(19) United States
(12) Patent Application Publication
(10) Pub. No.: US 2013/0307871 A1
(43) Pub. Date: Nov. 21, 2013

(54) Integrating Remote Content with Local Content

(71) Applicants: Anton Aleksandrov, Shfaim (IL); Amit Ben-Sheffer, Saba (IL); Todd Eric Kaplinger, Raleigh, NC (US)

(72) Inventors: Anton Aleksandrov, Shfaim (IL); Amit Ben-Sheffer, Saba (IL); Todd Eric Kaplinger, Raleigh, NC (US)

(73) Assignee: INTERNATIONAL BUSINESS MACHINES CORPORATION, Armonk, NY (US)

(21) Appl. No.: 13/474,506

(22) Filed: May 17, 2012

(51) Int. Cl. G09G 5/00; G06F 15/16

(52) U.S. Cl. 345/629

(57) ABSTRACT

Integrating remote content with local content includes operating an application on a mobile device using local content stored on the mobile device, retrieving remote content with an overlay component of the application, and displaying the local content and the remote content simultaneously in a display of the mobile device.

### BACKGROUND

The present invention relates to updating web resources, and more specifically, updating web resources on devices that download and operate applications.

Applications for mobile devices, such as electronic tablets and cell phones, may be downloaded over the internet. These applications allow users to do a variety of activities such as read literature, create illustrations, annotate documents, play games, and other activities. Often, a user virtually visits an online application store where such applications may be downloaded for free or purchased for a price.

### BRIEF SUMMARY

A method for integrating remote content with local content includes operating an application on a mobile device using local content stored on the mobile device, retrieving remote content with an overlay component of the application, and displaying the local content and the remote content simultaneously in a display of the mobile device.

A method for integrating remote content with local content includes operating an application on a mobile device using local content stored on the mobile device, retrieving remote content with an overlay component embedded in the application, and displaying the remote content in a display of the mobile device with local controls of the application.

A method for integrating remote content with local content includes operating an application on a mobile device using local content stored on the mobile device, retrieving remote content with a web view overlay component controlled with the application, and displaying the remote content in a display of the mobile device with machine readable instructions of the application while simultaneously displaying local content on the display.

A method for integrating remote content with local content includes operating an application on a mobile device using local content stored on the mobile device and remote content stored at a remote source with an overlay component embedded in the application, displaying the remote content in a display of the mobile device with machine readable instructions of the application while simultaneously displaying local content on the display, and controlling the remote content with the application.

### BRIEF DESCRIPTION OF THE SEVERAL VIEWS OF THE DRAWINGS

FIG. 1 is a diagram showing an illustrative device for integrating remote content with local content, according to one example of the principles described herein.

FIG. 2 is a diagram showing an illustrative device for integrating remote content with local content, according to one example of the principles described herein.

FIG. 3 is a diagram showing an illustrative device for integrating remote content with local content, according to one example of the principles described herein.

FIG. 4 is a diagram showing an illustrative method for integrating remote content with local content, according to one example of the principles described herein.

FIG. 5 is a diagram showing an illustrative processor, according to one example of the principles described herein.

FIG. 6 is a diagram showing an illustrative flowchart of a process for integrating remote content with local content, according to one example of the principles described herein.

### DETAILED DESCRIPTION

The present specification describes a method and system for integrating remote content with local content on mobile applications.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the uses computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

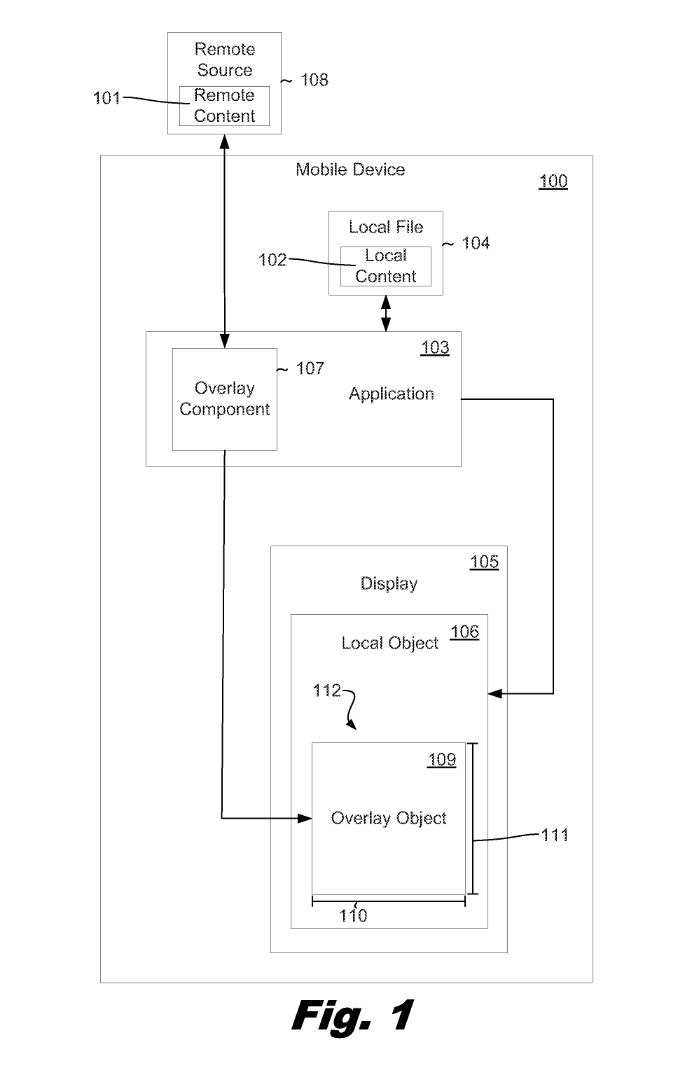

Referring now to the figures, FIG. 1 is a diagram showing an illustrative device (100) for integrating remote content (101) with local content (102). In this example, the device is a mobile device, such as an electronic tablet, a phone, a hand held electronic device, another mobile device, or combinations thereof.

An application (103) may be downloaded to the device (100) from an online application store, and the application (103) may be capable of performing tasks or other operations on the device (100). The application (103) may be run by a processor that performs the tasks associated with running the application (103). For example, the application (103) may have machine readable code that causes the processor to access local file (104) where local content (102) is stored. In some examples, the local content includes resources that are internal to the device (100). In some examples, the local content (102) includes resources that were pre-packaged in the application (103) and were installed on the device (100) when the application (103) was installed on the device (100).

The application (103) may be a third party application that was developed by a party other than a party who developed the device (100). Further, the deceive (100) may operate on a mobile operating system that has a platform that may run third party applications. The mobile operating system may be based on open code that is available to all developers. In other examples, the mobile operating system is based on proprietary code. In some examples, the mobile (100) is a phone that has a display and is capable of making and taking calls. In some examples, the application's code platform is written in a Java format.

The application (103) may include machine readable instructions that cause at least some of the local content (102) to be displayed on a display (105) in a local object (106). The local object (106) ma be a portion of the display (105) dedicated to displaying the local content (102). The local object (106) may include specific look and feel of the application (103) in the display (105). The local object (106) may also include navigation buttons, information, written text, icons, other content, or combinations thereof.

In some examples, the local object (106) is a webview. A webview may be a program that may run a browser and allow content to be viewed in a read-only mode. In some examples, the webview program is a written in a JavaScript. For example, a web view may display webpage content that local to the client device.

An overlay component (107) may be embedded into the application (103). The application (103) may contain machine readable instructions that cause the overlay component (107) to request and receive remote content (101) from a remote source (108), in some examples, the overlay component (107) is a web view component for retrieving and displaying remote content (101) that includes an online website. However, in some examples, the webview does not contain navigation features to navigate the remote content (101). In such examples, the controls of the local object (106) may provide the capability to navigate through the remote content (101). The overlay component (107) may request at least a portion of the remote content (101) from the remote source (108). In some examples, the remote source (108) is a server in communication with the device (100) over the internet. In response to the request, the remote source (108) may send the requested content to the overlay component (107).

The remote content (101) may be displayed in the display (105) of the device (100) in an overlay object (109). The overlay object (109) may a portion of the display (105) that is dedicated to showing the remote content (101). In some examples, the overlay component (107) is made within the local object (106). In other examples, the overlay object (109) takes up the entire display (105). The overlay object (109) may be controlled through the application (103). The remote content (101) may bypass processing from the processor that runs the application (103) and be displayed in the overlay object (109).

The application (103) may have machine readable instructions that specify at least one parameter of the overlay object (109). For example, the machine readable instructions may specify a shape of the overlay object (109), a width (110) of the overlay object (109), a length (111) of the overlay object (109), a size of the overlay object (109), a location (112) of the overlay object (109), another parameter of the overlay object (109), or combinations thereof.

In some examples, the application (103) is an application programmed for employees of a particular company, and the application (103) includes features that an employee may use for work or leisure. Some of the features may be supported with local content (102) while other features may be supported with the remote content (101). For example, features that are supported by the local content (102) may include reading material, problem solving tools, games, document mark-up tools, other features, or combinations thereof. In some examples, the application (103) includes a link to the company's website. The link may be embedded in the application's machine readable instructions, and the application (103) may create an overlay object (109) and request contents from the website. In this manner, the user may access the company's website through the application (103) even though the most of the application's components are downloaded to the device (100).

The user may benefit from such a device (100) because the user may access company information on the company's application and access additional company information from the company's website without having to switch from the application to a browser and vice versa. Thus, the device (100) may provide the user with a good user experience. The company may also benefit because the company may have the capability of providing their employees with services through specialized applications on such mobile devices without having to duplicate the services that are already provided on the company's website.

While the above example has been described in relation to a company's application and website, other types of applications and remote content may be used in accordance with the principles described herein. For example, a financial application may be available for download to mobile devices, and an overlay component of the application may have access to a dynamic, real time stock tracker. In such an example, the financial application have access its static information locally and provide the user with dynamic content that would otherwise need frequent updating. In other examples, the application is a specialized educational application with an overlay component in communication with a website containing the latest news in that specialized field.

In some examples, the overlay component (107) is in communication with remote content (101) that is dynamic and that may be unreliable if downloaded to the application (103) because the content would need frequent updating to be useful. In other examples, the remote content (101) is content that an application developer would prefer to not duplicate on the application (103). In other examples, the remote content (101) includes features for the application (103) that are likely to need periodic updates.

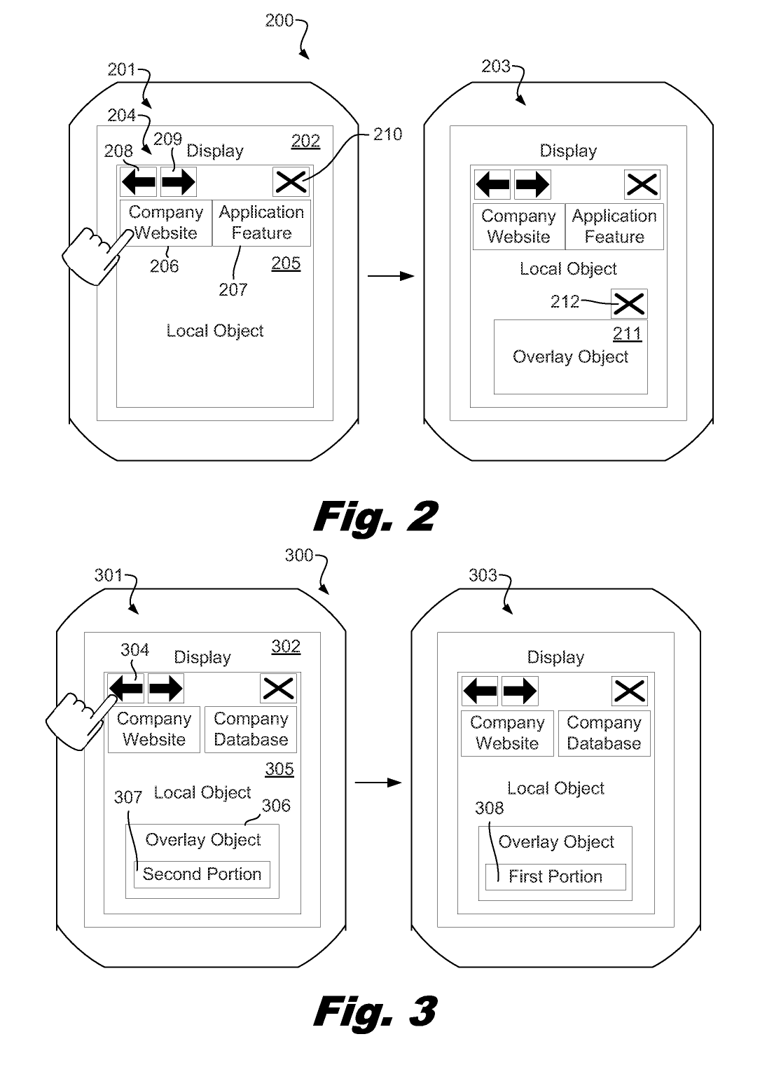

FIG. 2 is a diagram showing an illustrative device (200) for integrating remote content with local content. In this example, the device (200) is shown with a pre-click view (201) of the device's display (202) and a post-click view (203) of the device's display (202). In some examples, the device (200) includes a touch screen, a. multi-touch screen, a mouse, a scroll ball, a keyboard, a stylus, other communication interface mechanisms, or combinations thereof to communicate with the application.

In the example of FIG. 2, both the pre-click and the post-click views (201, 203) include a local object (205) of the application. In some examples, the local object (205) includes a company website button (206), an application feature button (207), a backwards navigation button (208), a forward navigation button (209), and an application close button (210).

The overlay component may be controlled by the user through the application. For example, in situations where the company website button (206) in the local object is clicked or otherwise selected, the application may respond by forming an overlay object (211), which is shown in the post-click view (203). Further, in response to the website button's selection, the application may request remote content from a remote source, retrieve the remote content with the overlay component, and present the remote content in the display with the overlay Object (211). Further, the overlay object may be created in the local object. If the overlay object close button (212) is selected, the application may close the overlay object (211). Thus, the overlay object (211) may be created and closed by a user through input given to the application. The overlay object's size, dimensions, position on the display, shape, or other parameters may be determined by the application. In some examples, the overlay's parameters are determined by specific dimensions written into the machine readable code of the application. In other examples, the overlay object's parameters are determined by a policy that governs the parameters while taking into account the other features of the application that are simultaneously displayed with the overlay object.

While the overlay object (211) is open, the user may interact with the remote content. For example, if the remote content is a website, the user may navigate through the website with the links and controls that are internal to the website. In such examples, the remote content may be sent to the overlay component and sent directly to the overlay object without further processing through the application. In some examples, the user performs at least some navigation tasks with the backwards navigation button (208) and the forward navigation button (209) of the local object (205).

In some examples, the application closes the overlay object in response to the selection of the backward navigation button (208). Likewise, in some examples, the forward navigation button (209) recreates overlay objects that may have been previously closed.

In some examples, a user is unaware that the device is using content from both a remote source and a local source. The device (200) may allow the user to view both local content and remote content on the same display simultaneously. Further, the device (200) may allow the user to use content from both local and remote sources at the same time.

The application feature button (207) may open a feature of the application. In some examples, the feature relies entirely on local content, relies entirely on remote content, or relies on both local and remote content. If the application relies in whole or in part on remote content, the device (200) may create an overlay object to operate the application. The application may shut its self down, including closing down the overlay component, in response to the selection of the application close button (210).

In some examples, more than one overlay component is embedded in the application. Each overlay component may have access to a different remote source and remote content. In some examples, each of the overlay components may form independent overlay objects in the local object. In other examples, a single overlay object may receive input from multiple overlay components.

In some examples, multiple overlay objects are formed in the local object at the same time. In such examples where multiple overlay objects are displayed simultaneously, the policy may modify overlay object's parameters to fit within the available space. However, in some examples where multiple overlay objects are open, the overlay object being interacted with by the use may be placed in the foreground, while the other open overlay objects may be placed in the background.

Further, in some examples, the client device is capable of operating multiple applications simultaneously. In such examples, multiple overlay objects may be open in different applications at the same time.

FIG. 3 is a diagram showing an illustrative device (300 for integrating remote content with local content. In this example, the device (300) is shown in a pre-click view (301) of the device's display (302) and in a post-click view (303) of the device's display (302). In this example, a backward navigation button (304) of the local object (305) is selected. In response, the application may instruct the overlay object (306) to go back from a current frame containing a second portion (307) of remote content to a previous frame that contained a first portion (308) of remote content, which is shown in the post-click view (303). For example, the first portion (308) of remote content may be a first webpage, and the second portion (307) may be a second webpage that the user had navigated to from the first webpage. By selecting the backward navigation button (304) of the local object (305), the application controls the overlay object (306). If the forward navigation button (309) were to be selected, the application may cause the overlay object (306) to move back to the frame that contained the second portion (307) of remote content.

The user may control the remote content as though the remote content is local content. For example, the user may be unaware that the application draws from both local and remote content. While the application's content is from different sources, it may appear to the use that the application's content is from a single source. For example, the ability to navigate through the remote content with navigation buttons in the local object help give the appearance to the user that the content comes from a common source. Further, using the native controls to control the overlay object, such as opening and closing the overlay component, may also give the user the feel that the content comes from a single source. Thus, developers may leverage content from multiple sources while providing the user with such a high level of ease that the user experience is as though the content comes from a common source. In other words, the content is displayed in such a manner that the remote and local content appear to come common sources. Further, the ability to control the remote content with the local controls may also cause the application to operate as though the content came from common sources.

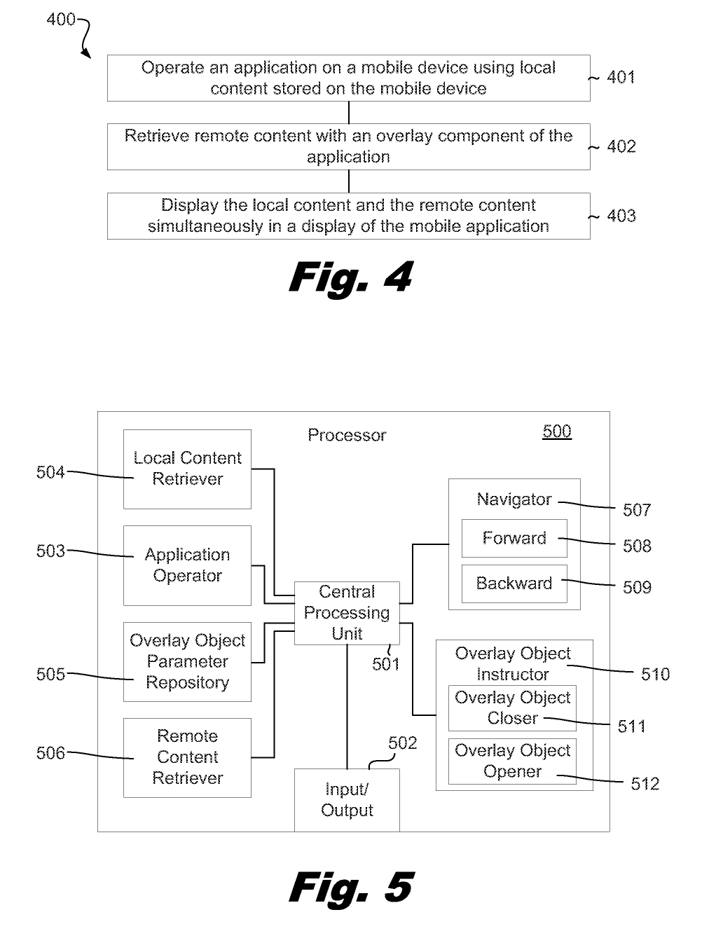

FIG. 4 is a diagram showing an illustrative method (400) for integrating remote content with local content. In this example, the method (400) includes operating (401) an application on a mobile device using local content stored on the mobile device, retrieving (402) remote content with an overlay component of the application, and displaying (403) the local content and the remote content simultaneously in a display of the mobile application.

In some examples, the overlay component is a web view component that is capable of accessing websites from remote locations. In other examples, the overlay component accesses dynamic remote content, such as stock quotes, real time measurements, breaking news, other dynamically changing content, or combinations thereof.

In some examples, the application contains machine readable instructions that define at least one parameter of an overlay object for displaying the remote content on the display. The parameter defined by the application may include a width of the overlay object, a length of the overlay object, a size of the overlay object, a location of the overlay object, or combinations thereof.

In sonic examples, the method includes communicating between the application and the overlay component. For examples, communicating may include the instructing the overlay component to open an overlay object, to close an overlay object, to switch from a first portion of the remote content to a second portion of the remote content, to navigate between the remote content and the local content with the application, other communications, or combinations thereof.

FIG. 5 is a diagram showing an illustrative processor (500). In this example, the processor (500) includes a central processing unit (CPU) (501) that is in communication with an input/output (502). The input/output (502) may be in communication with the application, the display, the local file, other locations, or combinations thereof.

The CPU (501) may be in communication with an application operator (503) that runs the application that is loaded to a mobile device, such as a phone or an electronic tablet. The processor (500) may retrieve local content from a local file with a local content retriever (504) and use that local content to run the application.

The processor (500) may also follow machine readable code of the application to control an overlay object. In FIG. 5, the processor (500) has an overlay object parameter repository (505) that contains the dimensions, shapes, lengths, width, position, other parameters, or combinations thereof of the overlay object. The processor (500) may also include a remote content retriever (506) that is programmed to send requests for content from remote sources. However, the remote content may be delivered to the overlay component instead of the processor (500). In some examples, the processor (500) instructs the overlay component to request the remote content.

The processor (500) may also contain a navigator (507) with space dedicated to forward navigation (508) and backward navigation (509). In some examples, the navigation is between local objects and overlay objects. In other examples, navigation is between portions of remote content. Further, in some examples, the processor (500) includes an overlay object instructor (510) that instructs the overlay object. An overlay object closer (511) of the overlay object instructor (510) may instruct the overlay Object to close. Also, an overlay object opener (512) of the overlay object instructor (510) may instruct the overlay object to open.

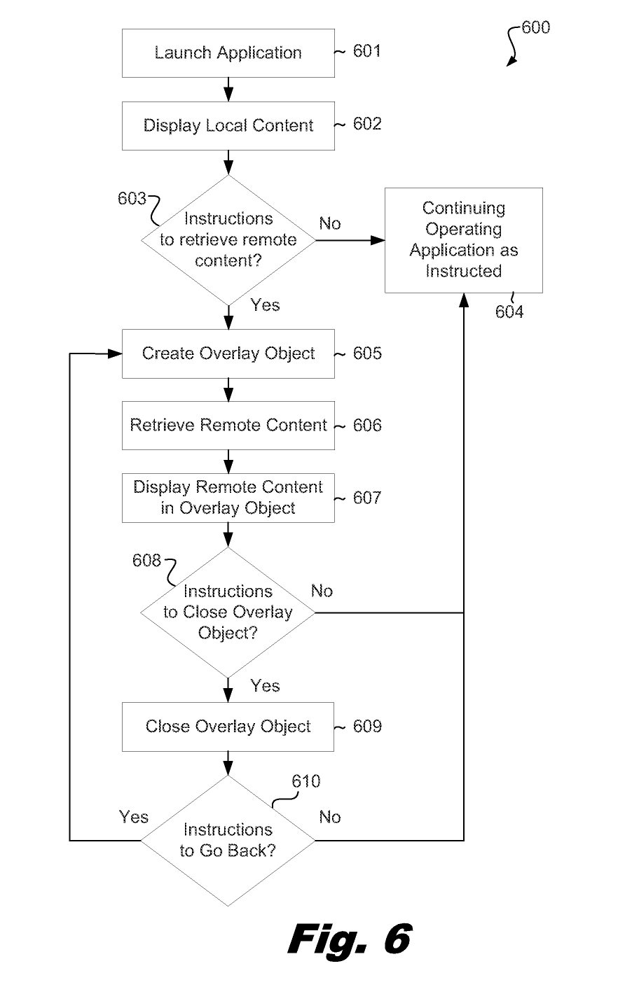

FIG. 6 is a diagram showing an illustrative flowchart (600) of a process for integrating remote content with local content. In this example, the process includes launching (601) an application on a mobile device. In some examples, the mobile device is a cell phone or an electronic tablet.

The application may display (602) local content stored on the application on a display while running the application. The process may include determining (603) whether there are instructions to retrieve remote content. The instructions may come from user inputs. For example, a user may give a command through the local objects of the application displayed on the mobile device to view content that is located of of the mobile device. In some examples, the user is unaware that the content is not stored locally.

If there are not instructions to retrieve remote content, the process may include continuing (604) to operate the application as instructed. However, if there are instructions to retrieve remote content, the process may include creating (605) an overlay object in the display of the mobile device, retrieving (606) remote content to put into an overlay component of the application, and displaying (607) the remote content in the overlay component in the overlay object.

The process may also include determining (608) whether there are instructions to close the overlay object. The instructions may come from user's instructions through interaction with the local object on the display. If there are no instructions to close the overlay object, then the process may continue (604) to operate the application as instructed.

If the application did receive instructions to close the overlay object, then the process may include closing (609) the overlay object. If so, then the process includes determining (610) whether the application received instructions to go back to the content in the overlay component. If the application received no instructions, then the process may include continuing (604) to operate the application as instructed. If the application did receive instructions to go back, then the process includes creating (605) an overlay object in the display of the mobile device, retrieving (606) remote content to put into an overlay component of the application, and displaying (607) the remote content in the overlay component in the overlay object.

In some examples, the remote location is located over the internet. However, in some examples, the remote location is located over a local area network, a wide area network, a satellite, a telecommunication network, other network, or combinations thereof.

While the above examples have been described with specific remote sources and specific mobile devices, any remote sources or mobile devices may be used according to the principles described herein. While some of the examples have been described with specific types of remote content, any remote content may be included within the scope of the principles described herein.

The descriptions of the various examples of the present invention have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

1. A method for integrating remote content with local content, comprising:
operating an application on a mobile device using local content stored on said mobile device;
retrieving remote content with an overlay component of said application; and
displaying said local content and said remote content simultaneously in a display of said mobile device.

2. The method of claim 1, wherein operating an application on a mobile device using local content stored on said mobile device includes operating the local content with a webview.

3. The method of claim 1, wherein said overlay component is a web view component.

4. The method of claim 1, wherein said application comprises machine readable instructions that define at least one parameter of an overlay object for displaying said remote content on said display.

5. The method of claim 3, wherein said at one parameter is selected from a group consisting of a width of said overlay object, a length of said overlay object, a size of said overlay object, a location of said overlay object, or combinations thereof.

6. The method of claim 1, further comprising communicating between said application and said overlay component.

7. The method of claim 5, wherein communicating between said application and said overlay component includes instructing said overlay component to open an overlay object.

8. The method of claim 5, wherein communicating between said application and said overlay component includes instructing said overlay component to close an overlay object.

9. The method of claim 5, wherein communicating between said application and said overlay component includes instructing said overlay component to switch from a first portion of said remote content to a second portion of said remote content.

10. The method of claim 1, furthering comprising navigating between said remote content and said local content with said application.

11. The method of claim 1, wherein said remote content is dynamically changing content.

12. The method of claim 1, further comprising controlling said remote content as though said remote content is local content.

13. A method for integrating remote content with local content, comprising:
operating an application on a mobile device using local content stored on said mobile device;
retrieving remote content with an overlay component embedded in said application; and
displaying said remote content in a display of said mobile device with local controls of said application.

14. The method of claim 13, wherein displaying said remote content in a display of said mobile device with local controls of said application includes displaying said local content and said remote content simultaneously in said display.

15. The method of claim 13, wherein said application comprises machine readable instructions that define at least one parameter of an overlay object for displaying said remote content on said display.

16. The method of claim 13, further comprising controlling said remote content as though said remote content is local content.

17. The method of claim 13, further comprising communicating between said application and said overlay component.

18. The method of claim 17, wherein communicating between said application and said overlay component includes instructing said overlay component to open an overlay object.

19. The method of claim 17, wherein communicating between said application and said overlay component includes instructing said overlay component to close an overlay object.

20. The method of claim 13, furthering comprising navigating between said remote content and said local content with said application.

21. A method for integrating remote content with local content, comprising:
operating an application on a mobile device using local content stored on said mobile device;
retrieving remote content with a web view overlay component controlled with said application; and
displaying said remote content in a display of said mobile device with an overlay component controlled with said application while simultaneously displaying local content on said display.

22. The method of claim 21, furthering comprising navigating between said remote content and said local content with said application.

23. The method of claim 21, wherein said application comprises machine readable instructions that define at least one parameter of an overlay object for displaying said remote content on said display.

24. A method for integrating remote content with local content, comprising:
operating an application on a phone using local content stored on said phone and remote content stored at a remote source with an overlay component embedded in said application;
displaying said remote content in a display of said phone with an overlay component while simultaneously displaying local content on said display; and
controlling said remote content with said application.

25. The method of claim 24, wherein controlling said remote content with said application includes opening said an overlay object in a display of said phone, closing said an overlay object in said display of said phone, navigating between said overlay object in said display and local content, or combinations thereof.
